(19) United States
(12) Patent Application Publication
(10) Pub. No.: US 2010/0141473 A1
(43) Pub. Date: Jun. 10, 2010

(54) INTELLIGENT APPLIANCE CONTROL SYSTEM

(76) Inventor: Jiun-Chau TZENG, Taipei City (TW)

Correspondence Address: HDLS Patent & Trademark Services, P.O. BOX 220746, CHANTILLY, VA, 20153-0746, US

(21) Appl. No.: 12/619,920

(22) Filed: Nov. 17, 2009

(30) Foreign Application Priority Data
Dec. 4, 2008 (TW) 097147087

(51) Int. Cl. G08C 19/00

(52) U.S. Cl. 340/825.72; 340/825.73

(57) ABSTRACT

An intelligent appliance control system comprises a remote control device and a base station. The remote control device comprises a first micro processor, a first display unit, a frequency identity button, a first control code learning button, a signal emission control button set, a storage unit, a frequency identification unit, a first control code learning unit, a second display unit, a third display unit and a first emission unit. The base station comprises a receive unit, a second micro processor unit, a third micro processor unit, an oscillate unit, an amplify unit and a second emission unit. The remote control device identifies and learns carrier frequencies and first control codes of remote controllers of various appliances. The carrier frequency data, a first control code and a second control code emitted by the remote control device are received and processed by the base station. Accordingly, the base station controls operations of appliances.

### BACKGROUND OF THE INVENTION

1. Field of the Invention

The invention generally relates to a remote control system, in particular, to a remote control system control appliances via a wireless remote control mechanism.

2. Description of Prior Art

It is common in modern life in a family using several remote controllers for controlling various appliances. There are disadvantages using several remote controllers such as inconveniences to choose among remote controllers, using several batteries which generate more pollution and in return higher cost to process the pollution generated. A remote controller using the technology of the present invention is capable of controlling several appliances which previously controlled by individual prior art infrared remote controllers. In other words, the present invention is applied in integrating function performed by several remote controllers into one remote controller.

Typically, a prior art universal infrared remote controller available on the shelf in a market is frequently implemented by a database. The mechanism is that the database is input with source control codes of several infrared remote controllers for various appliances and is saved in a memory. Prior to operating on the universal infrared remote controller, a user first finds out the serial number of the target remote controller from a chart, where serial numbers of infrared remote controllers from different models or different brands are listed. Then the user input corresponding serial number to the universal infrared remote controller. The major drawback of the prior art remote controller is that the database of the source control codes is not updated and does not contain source control codes for all appliances available in the market. Such disadvantage is inevitable as a result that there are plenty of infrared remote controllers of various models or brands available in the market. Not to mention that more and more new infrared remote controllers of various models or brands are now introduced and will be introduced to the market everyday, which make it literally impossible to include all source control codes in one database.

The other prior art technology is capable of learning source control codes of infrared remote controllers of different models or different brands and does not have the disadvantages caused by using a database. Yet, the technology is not optimized because source control codes of infrared remote controllers are modulated with a carrier frequency before infrared emission. There are several carrier frequencies used such as 30 KHz, 32 KHz, 33 KHz, 36 KHz, 38 KHz, 40 KHz, 56 KHz, and 455 KHz. In prior art technology, an infrared remote controller implemented to learn source control codes is designed to learn source control codes modulated by one frequency. Consequently, the prior art technology does not have the capability to replace infrared remote controllers of different models or different brands. In addition, a user generally is not given the carrier frequency of the target infrared remote controller the user wish to add to a universal infrared remote controller.

### SUMMARY OF THE INVENTION

The objective of the prevent invention is to provide an infrared remote controller for carrier frequency identification and single or dual learning on first control codes (source control codes). The infrared remote controller of the present invention is capable of replacing infrared remote controllers of different models or different brands, which realizes the goal to put functions of several remote controllers in one. The invention delivers conveniences in application and reduces the battery uses, which contribute to environmental protection.

In order to achieve the above-mentioned goal, the present invention provides an intelligent appliance control system having a remote control device for identifying and learning appliance remote controllers. The remote control device comprises a first micro processor unit, a frequency identity button, a frequency identification unit, a first control code learning button, a first control code learning unit, a signal emission control button set, and a first emission unit. The first micro processor unit serves as a computing core of the remote control device for generating a second control code. The frequency identity button is electrically connected to the first micro processor unit for generating a frequency identification control signal output to the first micro processor unit. The frequency identification unit is electrically connected to the first micro processor unit under the control of the first micro processor unit for identifying carrier frequency of the appliance remote controllers. The first control code learning button is electrically connected to the first micro processor unit for generating a learning control signal output to the first micro processor unit. The first control code learning unit is electrically connected to the first micro processor unit under the control of the first micro processor unit for learning a first control code of the appliance remote controllers. The signal emission control button set is electrically connected to the first micro processor unit for generating an appliance control signal output to the first micro processor unit. And the first emission unit is electrically connected to the first micro processor unit for emitting the carrier frequency data, a first control code and second control code output from the first micro processor unit.

In addition, the present invention further provides an intelligent appliance control system having a base station for receiving the emitted signals for controlling appliances. The base station comprises a receive unit, a second micro processor unit, a third micro processor unit, an oscillate unit, an amplify unit and a second emission unit. The receive unit is used for receiving carrier frequency data, a first control code and a second control code emitted output from the first emission unit. The second micro processor unit is electrically connected to the receive unit and used for receiving the carrier frequency data, the first control code and the second control code output from the receive unit and determining if the second control code is correct and if carrier frequency oscillation generated by the third micro processor unit is sufficient. The third micro processor unit is electrically connected to the second micro processor unit and used for receiving the carrier frequency data and the first control code output from the second micro processor unit for generating different carrier frequencies output. The amplify unit is electrically connected to the third micro processor unit and used for amplifying the carrier frequency output from third micro processor unit. And the second emission unit is electrically connected to the amplify unit and used for emitting the carrier frequency to appliances.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 illustrates a circuit block diagram of the remote control device in the first preferred embodiment according to the present invention;

FIG. 2 illustrates a circuit block diagram of the base station in the first preferred embodiment according to the present invention;

FIG. 3a-3f are circuit wiring diagram of the circuit shown in and FIG. 1 and FIG. 2;

FIG. 4 illustrates the control flow chart according to the present invention; and

FIG. 5 illustrates an integrated circuit block diagram of the remote control device and the base station in the second embodiment according to the present invention.

### DETAILED DESCRIPTION OF THE INVENTION

In cooperation with attached drawings, the technical contents and detailed description of the present invention are described thereinafter according to preferable embodiments.

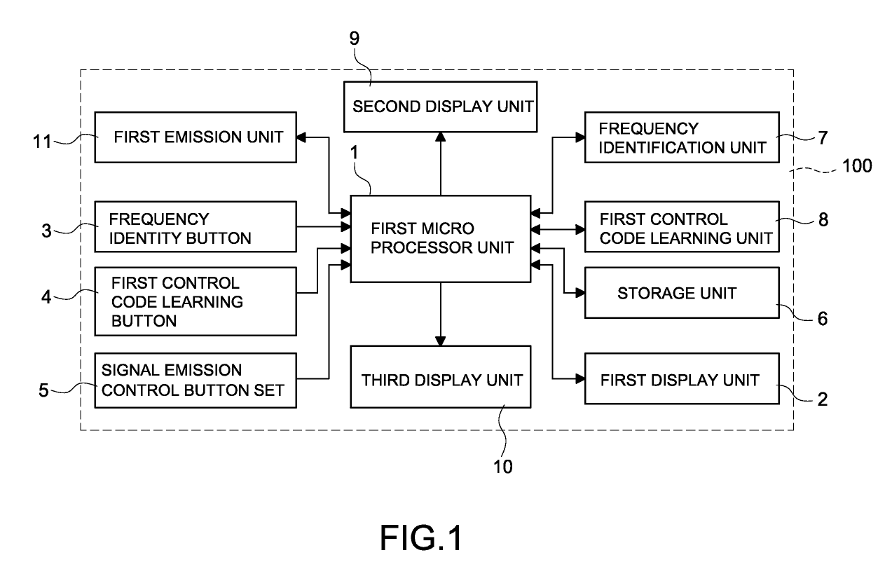

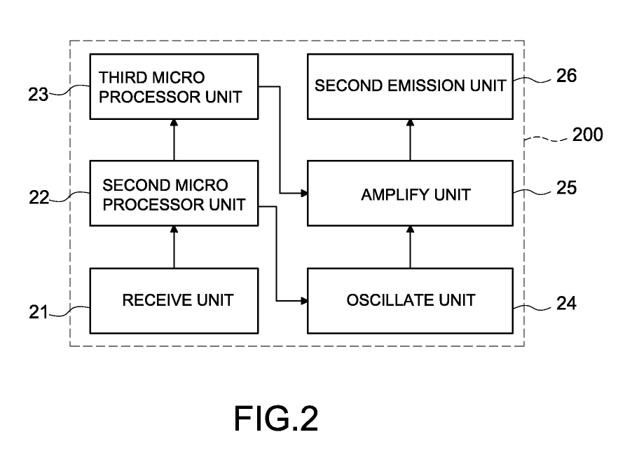

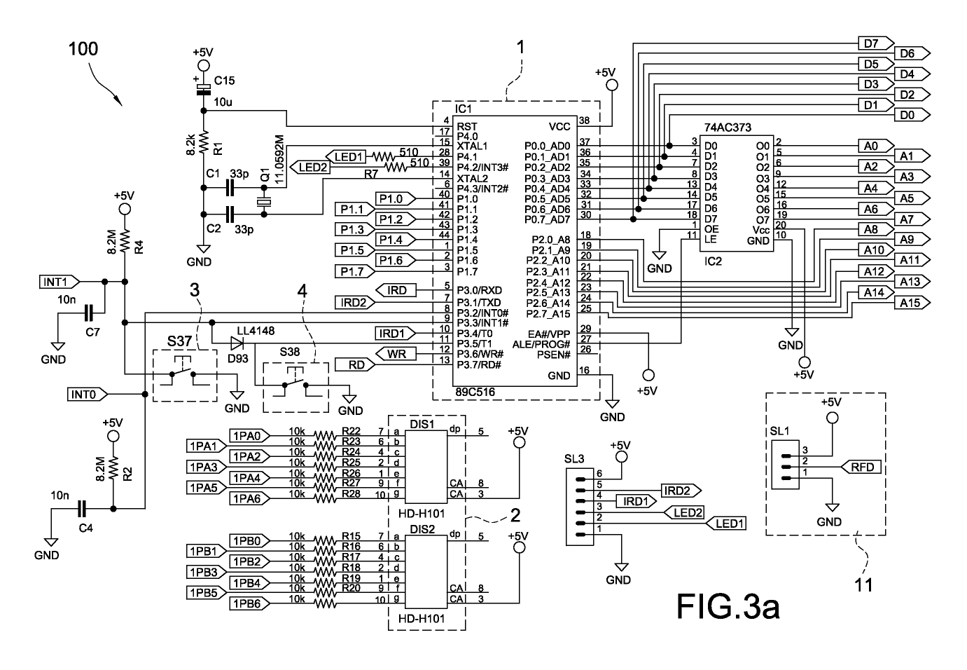

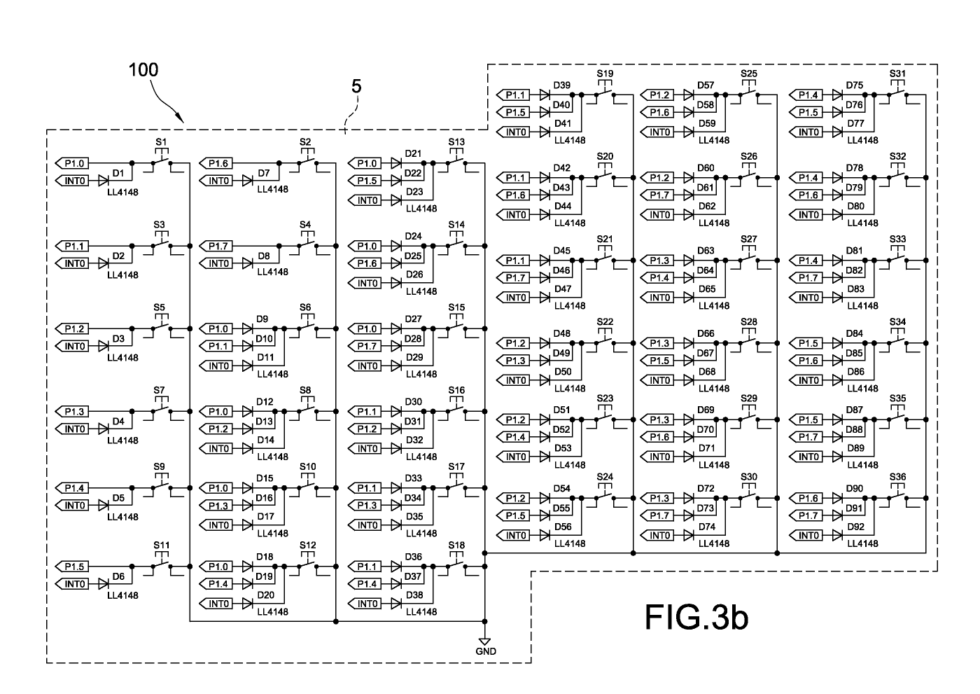

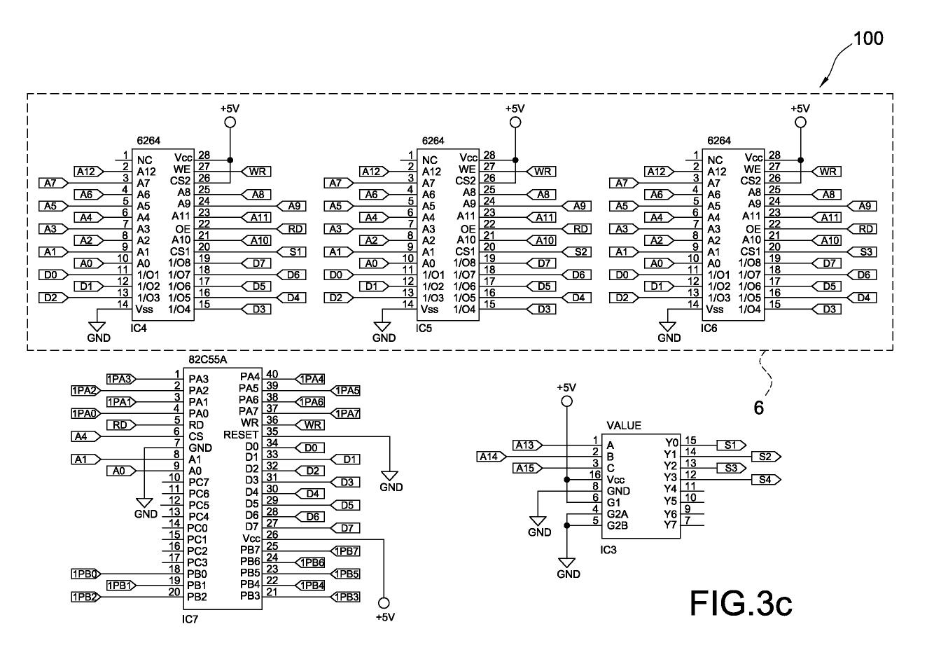

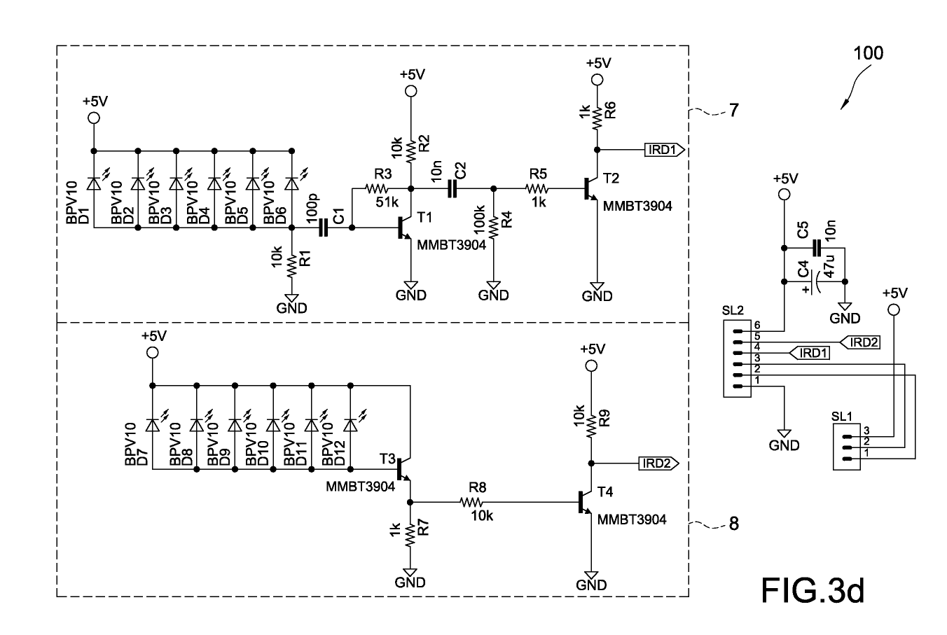

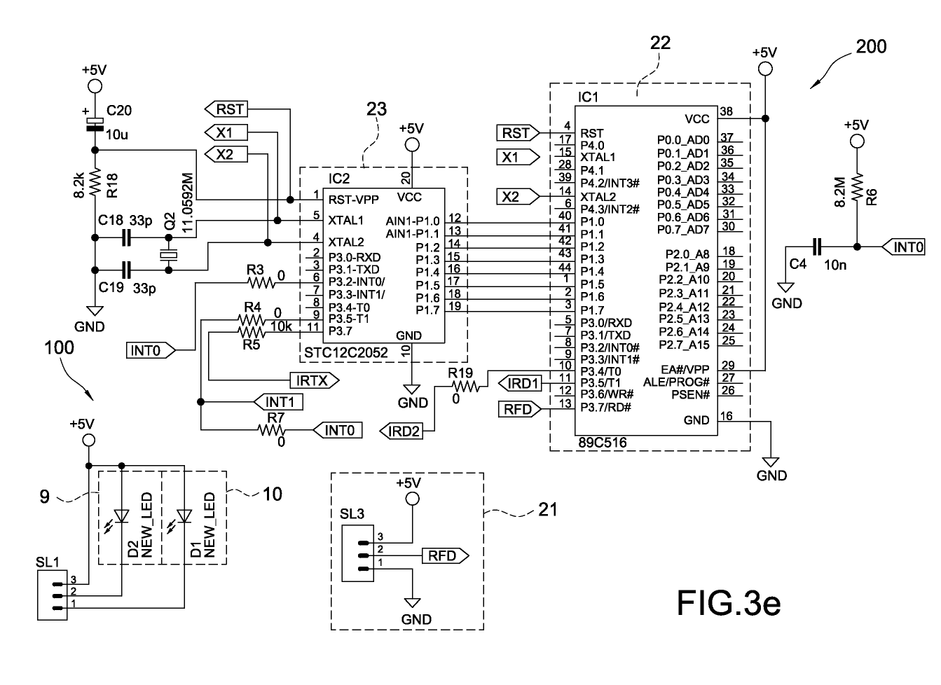

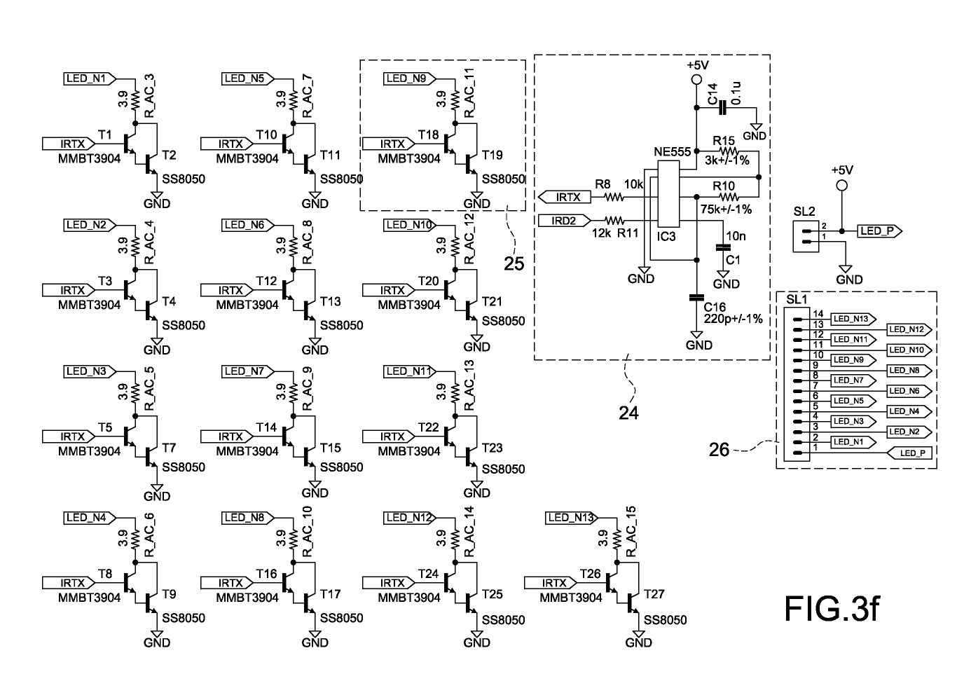

FIG. 1 and FIG. 2 illustrate circuit block diagrams of the remote control device and the base station in the first preferred embodiment according to the present invention and FIG. 3a-3f are circuit wiring diagram of the circuit shown in FIG. 1 and FIG. 2. As shown in the diagrams, the intelligent appliance control system according to the present invention comprises a remote control device 100 and a base station 200.

The remote control device 100 comprises a first micro processor unit 1, a first display unit 2, a frequency identity button 3, a first control code learning button 4, a signal emission control button set 5, a storage unit 6, a frequency identification unit 7, a first control code learning unit 8, a second display unit 9, a third display unit 10 and a first emission unit 11. The first micro processor unit 1 is electrically connected to all units and all buttons and serves as a computing core of the remote control device 100. Upon the frequency identity button 3 is pressed, a signal is output to the first micro processor unit 1. Simultaneously, the first micro processor unit 1 triggers the second display unit 9 and the frequency identification unit 7 and enables the remote control device 100 entering a carrier frequency identification mode. The frequency identification unit 7 identifies carrier frequencies of remote controllers of other models or brands (not shown in the diagram) and transmits the identification result of carrier frequencies to the first micro processor unit 1. The first micro processor unit 1 saves the identification result of carrier frequencies in a storage unit 6 implemented by a memory. Simultaneously, the first display unit 2 displays identified carrier frequency. Following the identifying step, the remote control device 100 enters a power saving mode. In the FIG. 1 and FIG. 2, the second display unit is made of light emitting diodes (LEDs) and the first display unit 2 is a seven-segment display or liquid crystal display.

Upon first control code learning button 4 is pressed, a signal is output to the first micro processor unit 1. Simultaneously, the first micro processor unit 1 triggers the third display unit 10 and the first control code learning unit 8 and enables the remote control device 100 entering a first control code learning mode. The first control code learning unit 8 learns a first control code (source control code) of remote controllers of other models or brands (not shown in the diagrams), and transmits learnt first control code to the first micro processor unit 1. The first micro processor unit 1 saves the learnt first control code in the storage unit 6. Following the first control code learnt, the remote control device 100 enters the power saving mode. In the FIG. 1 and FIG. 2, the third display unit is made of LEDs.

The signal emission control button set 5 is formed by a plurality of buttons. The button set comprises at least a number button, a text button, a volume button, a channel select button, a setup button, a menu button, a direction control button, a display button, a play button, a pause button, a stop button and a switch button for switching control between appliances. Upon one of previous mentioned buttons is pressed, a control signal is transmitted to the first micro processor unit 1. The first emission unit 11 emits signals of the carrier frequency data and the first control code and the second control code. The second control code can be digital codes generated by user definition (for example an ID code) such that the control code is not received by other base station and causes confusion.

Under the circumstance the remote control device 100 identifies or learns a remote controller of an air conditioner, the first display unit 2 is configured to display a setup temperature of the air conditioner when the air conditioner is in use.

The base station 200 comprises a receive unit 21, a second micro processor unit 22, a third micro processor unit 23, an oscillate unit 24, an amplify unit 25 and a second emission unit 26.

The receive unit 21 receives signals of the carrier frequency data, a first control code and a second control code emitted from the remote control device 100 and transmits the data and the codes to the second micro processor unit 22. The second micro processor unit 22 first determines if the second control code is correct. If yes, the second micro processor unit 22 receives and saves the carrier frequency data and the first control code in a memory built in the second micro processor unit 22.

At the same time, as the second micro processor unit 22 determines if the second control code is correct, the second micro processor unit 22 also determines if the carrier oscillation frequency generated by the third micro processor unit is sufficient. If the carrier oscillation frequency by the third micro processor unit is sufficient, the second micro processor 22 transmits the carrier frequency data and the first control code to the third micro processor unit 23. The third micro processor unit 23 generates corresponding carrier frequency output (for example at 30 KHz, 32 KHz, 33 KHz, 36 KHz, 38 KHz, 40 KHz, 56 KHz), and transmits generated carrier frequency to the amplify unit 25. The amplify unit 25 amplifies the carrier frequency. Then the second emission unit 26 transmits the amplified signal to the target appliance to control the appliance (for example, turn on a television, select television channel or play audio/video files).

If the second micro processor unit 22 determines that received carrier frequency generated by the third micro processor unit is not sufficient, the second micro processor 22 outputs the signals to the oscillate unit 24 for generating a higher carrier frequency (for example at 455 KHz). The signal of higher carrier frequency is then transmitted to the amplify unit 25. The amplify unit 25 amplifies the carrier frequency. Subsequently, the second emission unit 26 emits the signal to the target appliance to control the appliance.

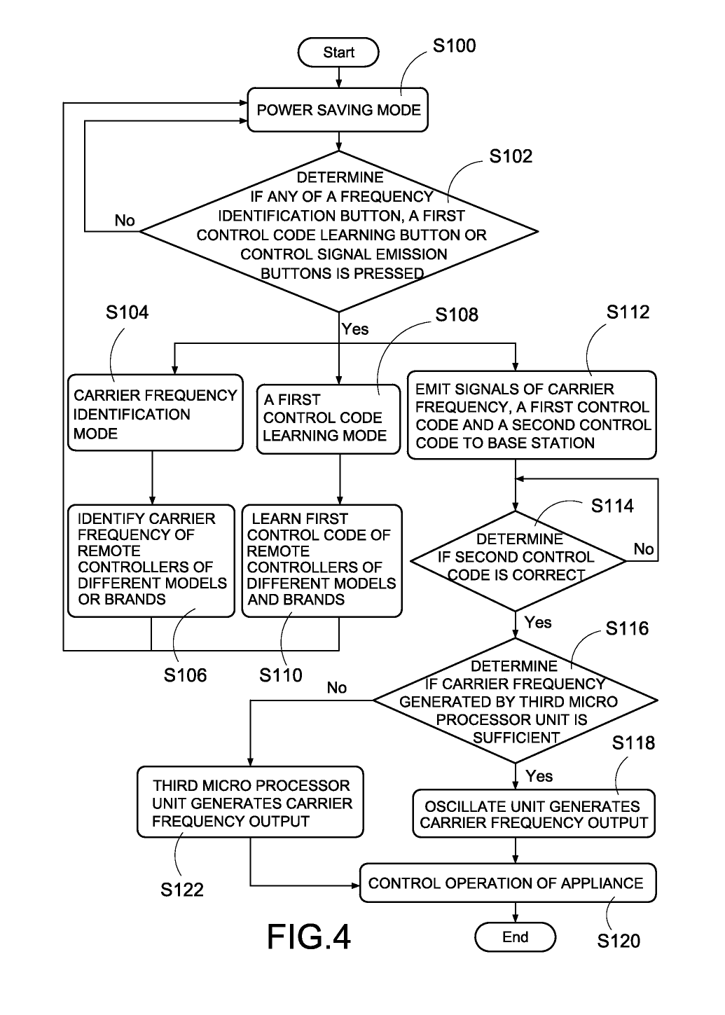

FIG. 4 illustrates the control flow chart according to the present invention. As shown in the diagram, as the remote control device 100 is power on, the device 100 first enters into a power saving mode in step s100.

In step s102, a step to determine if any of a frequency identification button, a first control code learning button or control signal emission buttons is pressed. If not, the process proceeds to step s100. If the frequency identity button is pressed, the process enters into a carrier frequency identification mode in step s104. Then the process enters into step s106 to identify the carrier frequency of remote controllers of different models or brands. Following the identifying step is completed, the process proceeds to step s100.

If the step s102 determines that the first control code learning button is pressed, the process proceeds into a first control code learning mode in step s108, then enters into a step to learn first control code of the remote controllers of different models and brands in step s110. Following the leaning step is completed, the process proceeds to step s100.

If the step s102 any button among the signal emission control button set is pressed, the process proceeds to emit signals of carrier frequency, a first control code and a second control code to a base station in step s112.

The base station receives signals of the carrier frequency data, the first control code and the second control code. Then the process enters into step s114 to determine if the second control code is correct. If not, then the determining step is repeated. If yes, the process proceeds to step s116 to determine if the carrier frequency generated by the third micro processor unit is sufficient. If not, the process proceeds to step s118. In step s118, the oscillate unit generates the carrier frequency output. Then the process proceeds to step s120 to control operation of the target appliance. On the other hand, if the carrier frequency generated by the third micro processor unit is determined sufficient, the process proceeds to step s122. In step s122, the third micro processor unit generates the carrier frequency output. Then the process proceeds to step s120 to control operation of the target appliance.

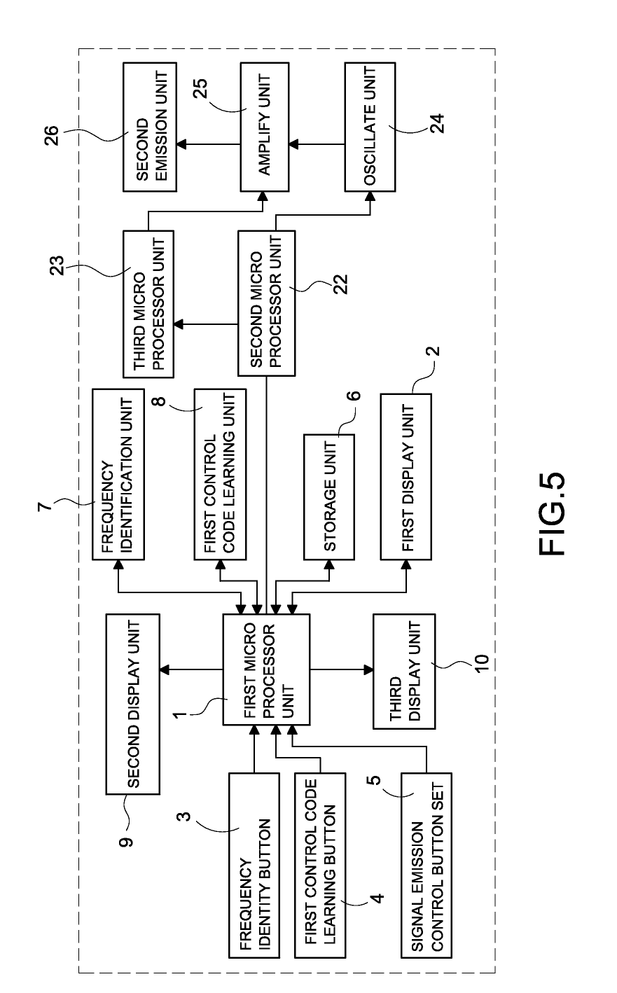

FIG. 5 illustrates an integrated circuit block diagram of the remote control device and the base station in the second embodiment according to the present invention. As shown in the diagram, a first micro processor unit 1 of a remote control device 100 is electrically connected to a second micro processor unit 22 of a base station 200 electrically connected in the second embodiment. If any buttons of signal emission control button set 5 is pressed, a first micro processor unit 1 processes and transmits carrier frequency and a first control code to a second micro processor unit 22 and leave out the steps performed by a first emission unit 11 and a receive unit 21 to simplify the overall appliance control system.

As the skilled person will appreciate, various changes and modifications can be made to the described embodiments. It is intended to include all such variations, modifications and equivalents which fall within the scope of the invention, as defined in the accompanying claims.

What is claimed is:

1. An intelligent appliance control system having a remote control device for identifying and learning appliance remote controllers, the remote control device comprising:
a first micro processor unit serving as a computing core of the remote control device for generating a second control code;
a frequency identity button electrically connected to the first micro processor unit for generating a frequency identification control signal output to the first micro processor unit;
a frequency identification unit electrically connected to the first micro processor unit under the control of the first micro processor unit for identifying carrier frequency of the appliance remote controllers;
a first control code learning button electrically connected to the first micro processor unit for generating a learning control signal output to the first micro processor unit;
a first control code learning unit electrically connected to the first micro processor unit under the control of the first micro processor unit for learning a first control code of the appliance remote controllers;
a signal emission control button set electrically connected to the first micro processor unit for generating an appliance control signal output to the first micro processor unit; and
a first emission unit electrically connected to the first micro processor unit for emitting the carrier frequency data, a first control code and second control code output from the first micro processor unit.

2. The intelligent appliance control system of claim 1, wherein the carrier frequencies are 30 KHz, 32 KHz, 33 KHz, 36 KHz, 38 KHz, 40 KHz, 56 KHz, and 455 KHz.

3. The intelligent appliance control system of claim 1, wherein the first control code is a source control code.

4. The intelligent appliance control system of claim 1, wherein the second control code is an ID code.

5. The intelligent appliance control system of claim 1, wherein the remote control device further comprise a first display unit, a second display unit and a third display unit, the first display unit is electrically connected to the first micro processor unit for displaying the carrier frequency and a setup air conditioning temperature, the second display unit is electrically connected to the first micro processor unit for displaying the remote control device is under the mode of identifying the carrier frequency, and the third display unit is electrically connected to the first micro processor unit for displaying the remote control device is under the mode of learning the first control code.

6. The intelligent appliance control system of claim 1, wherein the remote control device further comprises a storage unit electrically connected to the first micro processor unit for saving the carrier frequency data and a first control code.

7. The intelligent appliance control system of claim 1, wherein the signal emission control button set comprises a plurality of buttons, the control button set comprises at least a number button, a text button, a volume button, a channel select button, a setup button, a menu button, a direction control button, a display button, a play button, a pause button, a stop button and a switch button for switching control between appliances.

8. An intelligent appliance control system having a base station for receiving the emitted signals for controlling appliances in claim 1, the base station comprising: a receive unit, a second micro processor unit, a third micro processor unit, an oscillate unit, an amplify unit and a second emission unit, wherein
the receive unit is used for receiving carrier frequency data, a first control code and a second control code emitted output from the first emission unit of claim 1;
the second micro processor unit is electrically connected to the receive unit and used for receiving the carrier frequency data, the first control code and the second control code output from the receive unit and determining if the second control code is correct and if carrier frequency oscillation generated by the third micro processor unit is sufficient;
the third micro processor unit is electrically connected to the second micro processor unit and used for receiving the carrier frequency data and the first control code output from the second micro processor unit for generating different carrier frequencies output;
the amplify unit is electrically connected to the third micro processor unit and used for amplifying the carrier frequency output from third micro processor unit; and
the second emission unit is electrically connected to the amplify unit and used for emitting the carrier frequency to appliances.

9. The intelligent appliance control system of claim 8, wherein the carrier frequencies are 30 KHz, 32 KHz, 33 KHz, 36 KHz, 38 KHz, 40 KHz, 56 KHz, and 455 KHz.

10. The intelligent appliance control system of claim 8, wherein the first control code is a source control code.

11. The intelligent appliance control system of claim 8, wherein the second control code is an ID code.

12. The intelligent appliance control system of claim 8, wherein the oscillate unit is electrically connected to the second micro processor unit and amplify unit, the second micro processor unit controls the oscillate unit to generate a higher carrier frequency to transmit to the amplify unit when the second micro processor unit determines that the carrier frequency oscillation generated by the third micro processor unit is not sufficient.

13. An intelligent appliance control system having a remote control device used for controlling appliances and having remote controllers for identifying and learning appliance, the remote control device comprising:
a first micro processor unit as a computing core of the remote control device;
a frequency identity button electrically connected to the first micro processor unit for generating a frequency identification control signal output to the first micro processor unit;
a frequency identification unit electrically connected to the first micro processor unit under the control of the first micro processor unit for identifying carrier frequency of the appliance remote controllers;
a first control code learning button electrically connected to the first micro processor unit for generating a learning control signal output to the first micro processor unit;
a first control code learning unit electrically connected to the first micro processor unit under the control of the first micro processor unit for learning the a first control code of appliance remote controllers; and
a signal emission control button set electrically connected to the first micro processor unit for generating an appliance control signal output to the first micro processor unit;
a second micro processor unit electrically connected to the first micro processor unit for receiving carrier frequency data and a first control code output from the first micro processor unit;
a third micro processor unit electrically connected to the second micro processor unit for receiving the carrier frequency data and the first control code output from the second micro processor unit for generating different carrier frequencies output, the second micro processor unit determining carrier frequency oscillation generated by the third micro processor unit is sufficient;
an amplify unit electrically connected to the third micro processor unit for amplifying the carrier frequency output from the third micro processor unit;
a second emission unit electrically connected to the amplify unit for emitting the carrier frequency to appliance.

14. The intelligent appliance control system of claim 13, wherein the carrier frequencies are 30 KHz, 32 KHz, 33 KHz, 36 KHz, 38 KHz, 40 KHz, 56 KHz, and 455 KHz.

15. The intelligent appliance control system of claim 13, wherein the first control code is a source control code.

16. The intelligent appliance control system of claim 13, wherein the remote control device further comprise a first display unit and a second display unit, the first display unit is electrically connected to the first micro processor unit for displaying the carrier frequency and a setup air conditioning temperature, and the second display unit is electrically connected to the first micro processor unit for displaying the remote control device is under the mode of identifying the carrier frequency.

17. The intelligent appliance control system of claim 13, wherein the remote control device further comprises a third display unit electrically connected to the first micro processor unit for displaying the remote control device is under the mode of learning the first control code.

18. The intelligent appliance control system of claim 13, wherein the remote control device further comprises a storage unit electrically connected to the first micro processor unit for saving the carrier frequency data and the first control code.

19. The intelligent appliance control system of claim 13, wherein the signal emission control button set comprises a plurality of buttons, the control button set comprises at least a number button, a text button, a volume button, a channel select button, a setup button, a menu button, a direction control button, a display button, a play button, a pause button, a stop button and a switch button for switching control between appliances.

20. The intelligent appliance control system of claim 13, wherein the remote control device further comprises an oscillate unit electrically connected to the second micro processor unit and amplify unit, the second micro processor unit controls the oscillate unit to generate a higher carrier frequency to transmit to the amplify unit when the second micro processor unit determines that the carrier frequency oscillation generated by the third micro processor unit is not sufficient.
